(19) United States
(12) Patent Application Publication
(10) Pub. No.: US 2006/0059515 A1
(43) Pub. Date: Mar. 16, 2006

(54) Apparatus and method for displaying program listing

(75) Inventor: Akira Miyazawa, Saitama-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/219,907

(22) Filed: Sep. 7, 2005

(30) Foreign Application Priority Data
Sep. 16, 2004 (JP) 2004-269926

(51) Int. Cl. H04N 5/445; G06F 13/00; G06F 3/00

(52) U.S. Cl. 725/42; 725/39; 725/40

(57) ABSTRACT

A program listing displaying apparatus includes an obtaining unit configured to obtain program information, a producing unit configured to produce an electronic program listing based on the obtained program information, a display unit configured to display a part of area of the produced electronic program listing, and a switching unit configured to perform page switch of the area of the displayed electronic program listing to the area, which exists in a specified direction and continuously follows the displayed area.

### CROSS-REFERENCE TO RELATED APPLICATIONS

This application is based upon and claims the benefit of priority from prior Japanese Patent Application No. 2004-269926, filed Sep. 16, 2004, the entire contents of which are incorporated herein by reference.

### BACKGROUND OF THE INVENTION

1. Field of the Invention

The present invention relates to an apparatus and a method for displaying a program listing, which are preferably used for a digital television broadcasting receiving apparatus and the like.

2. Description of the Related Art

As is well known, recently digitization of television broadcasting is promoted. For example, in Japan, not only satellite digital broadcasting such as BS (broadcasting satellite) digital broadcasting and 110-degree CS (communication satellite) digital broadcasting but also terrestrial digital broadcasting have been started.

In the digital television broadcasting receiving apparatus which receives the digital television broadcasting, an electronic program listing is produced based on EPG (Electronic Program Guide) information obtained from a broadcasting signal, and the electronic program listing is displayed on a screen. A user can select the desired program from the displayed electronic program listing, and the user can watch the program or reserve the program.

The EPG information includes one in which the electronic program listings of about one week can be produced with respect to each of many broadcasted channels. Therefore, in the digital television broadcasting receiving apparatus, since all the electronic program listings cannot simultaneously be displayed on the limited screen, the electronic program listings are displayed on the screen while partially switched. At this point, it is important how much a display area switching operation of the electronic program listing is simplified and how much user-operability is improved.

In a technology disclosed in Jpn. Pat. Appln. KOKAI Publication No. 2001-169197, a data axis is added in a depth direction in a two-dimensional program listing including a time axis and a broadcasting station axis, and a viewing audience can intuitively search and select the program by moving a cursor in all the directions.

In a technology disclosed in Jpn. Pat. Appln. KOKAI Publication No. 2001-238145, a user specifies a category of the program, the user operates a cursor moving key while the program of the specified category is selected on the program listing, and thereby the program nearest to the same category is selected in the moving direction specified by the cursor moving key.

In a technology disclosed in Jpn. Pat. Appln. KOKAI Publication No. 10-93880, the program listing is formed in a virtual three-dimensional body, a mapping position is changed only for the minimal program listings by utilizing link information between pieces of program data during scrolling the program listing, and thereby a user can intuitively perform the operation and program data can be displayed at a high speed.

### BRIEF SUMMARY OF THE INVENTION

According to one aspect of the present invention, there is provided a program listing displaying apparatus comprising: an obtaining unit configured to obtain program information; a producing unit configured to produce an electronic program listing based on the program information obtained by the obtaining unit; a display unit configured to display a part of area of the electronic program listing produced by the producing unit; and a switching unit configured to perform page switch of the area of the electronic program listing displayed by the display unit to the area which exists in a specified direction, the area continuously following the area displayed by the display unit.

According to another aspect of the present invention, there is provided a program listing displaying method comprising: a step of obtaining program information; a step of producing an electronic program listing based on the obtained program information; a step of displaying a part of area of the produced electronic program listing; and a step of performing page switch of the area of the displayed electronic program listing to the area, which exists in a specified direction and continuously follows the displayed area.

### BRIEF DESCRIPTION OF THE SEVERAL VIEWS OF THE DRAWING

FIG. 1 is a view for schematically explaining a digital television broadcasting receiving apparatus according to an embodiment of the invention and a network system mainly formed by the digital television broadcasting receiving apparatus;

FIG. 2 is a block diagram showing a main signal processing system of the digital television broadcasting receiving apparatus of the embodiment;

FIG. 3 is an external appearance of a remote controller of the digital television broadcasting receiving apparatus of the embodiment;

FIG. 4 is a flowchart showing an action in which the digital television broadcasting receiving apparatus of the embodiment performs display switch of the electronic program listings;

FIG. 5 is a view for explaining an electronic program listing displayed by the digital television broadcasting receiving apparatus of the embodiment;

FIG. 6 is a view for explaining an electronic program listing after page switch in the embodiment;

FIG. 7 is a view for explaining another electronic program listing after the page switch in the embodiment;

FIG. 8 is a schematic view for explaining the display switch of the electronic program listings in the embodiment;

FIG. 9 is an external appearance of another remote controller of the digital television broadcasting receiving apparatus of the embodiment; and

FIG. 10 is an external appearance of still another remote controller of the digital television broadcasting receiving apparatus of the embodiment.

### DETAILED DESCRIPTION OF THE INVENTION

An embodiment of the invention will be described in detail with reference to the accompanying drawings.

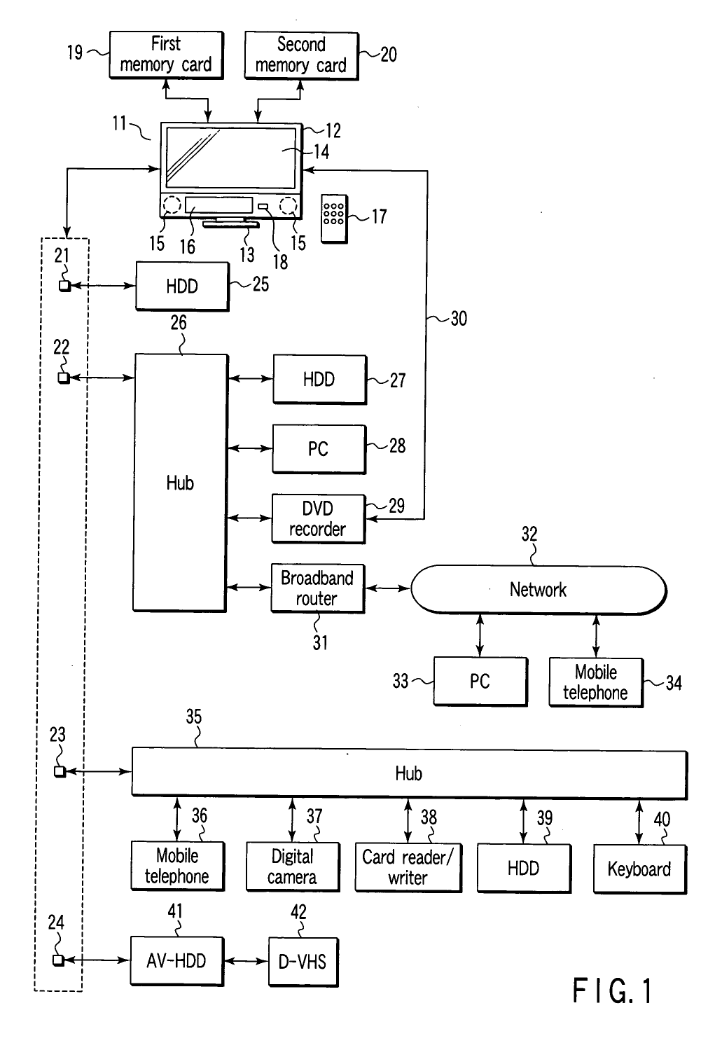

FIG. 1 shows an external appearance of a digital television broadcasting receiving apparatus 11 according to an embodiment of the invention and a network system mainly formed by the digital television broadcasting receiving apparatus 11.

The digital television broadcasting receiving apparatus 11 mainly includes a thin cabinet 12 and a mounting support 13 which vertically supports the cabinet 12. The cabinet 12 includes a flat panel type video display device 14 for example formed by a liquid crystal display panel, a speaker 15, an operation unit 16, a remote controller 17, and a light-reception unit 18 which receives operation information transmitted from the remote controller 17.

A first memory card 19 such as an SD (Secure Digital) memory card, MMC (Multi Media Card), and a memory stick is detachable to the digital television broadcasting receiving apparatus 11. The recording and reproduction of the information such as programs and photographs are performed to the first memory card 19.

A second memory card (IC card) 20 in which, for example, contract information is recorded is detachable to the digital television broadcasting receiving apparatus 11. The recording and reproduction of the information are performed to the second memory card 20.

The digital television broadcasting receiving apparatus 11 includes a first LAN (Local Area Network) terminal 21, a second LAN terminal 22, a USB (universal Serial Bus) terminal 23, and an i.Link terminal 24.

The first LAN terminal 21 is provided as a LAN-compatible HDD dedicated port, and the first LAN terminal 21 is used for the information recording and reproduction through Ethernet (registered trademark) with respect to a LAN-compatible HDD 25 which is a connected NAS (Network Attached Storage).

Thus, the provision of the first LAN terminal 21 as the LAN-compatible HDD dedicated port enables the stable program information recording into the LAN-compatible HDD 25 with high-definition image quality while the program information recording is not affected by other network environments or a working condition of the network.

The second LAN terminal 22 is provided as a general LAN-compatible port in which the Ethernet (registered trademark) is used. The second LAN terminal 22 is connected to devices such as a LAN-compatible HDD 27, PC (Personal Computer) 28, and a DVD (digital versatile disk) recorder 29 with a built-in HDD through a hub 26, and the second LAN terminal 22 is used for information transmission between the digital television broadcasting receiving apparatus 11 and the devices.

Because the digital information communicated through the second LAN terminal 22 is only the information on the control system, it is necessary that a dedicated analog transmission line 30 is provided for the DVD recorder 29 in order to transmit the analog video information and the analog sound information between the digital television broadcasting receiving apparatus 11 and the DVD recorder 29.

The second LAN terminal 22 is connected to a network 32 such as the Internet through a broadband router 31 connected to the hub 26, and the information transmission is made with a PC 33 and a mobile phone 34 through the network 32.

The USB terminal 23 is used as a general USB-compatible port. For example, the USB terminal 23 is connected to USB devices such as a mobile phone 36, a digital camera 37, a card reader/writer 38 for the memory card, an HDD 39, and a keyboard 40 through a hub 35, and the information transmission is made with the USB devices.

The i.Link terminal 24 is used in order that an AV-HDD 41, a D (Digital)-VHS (Video Home System) 42, and the like are connected in serial to make the information transmission between the digital television broadcasting receiving apparatus 11 and these devices.

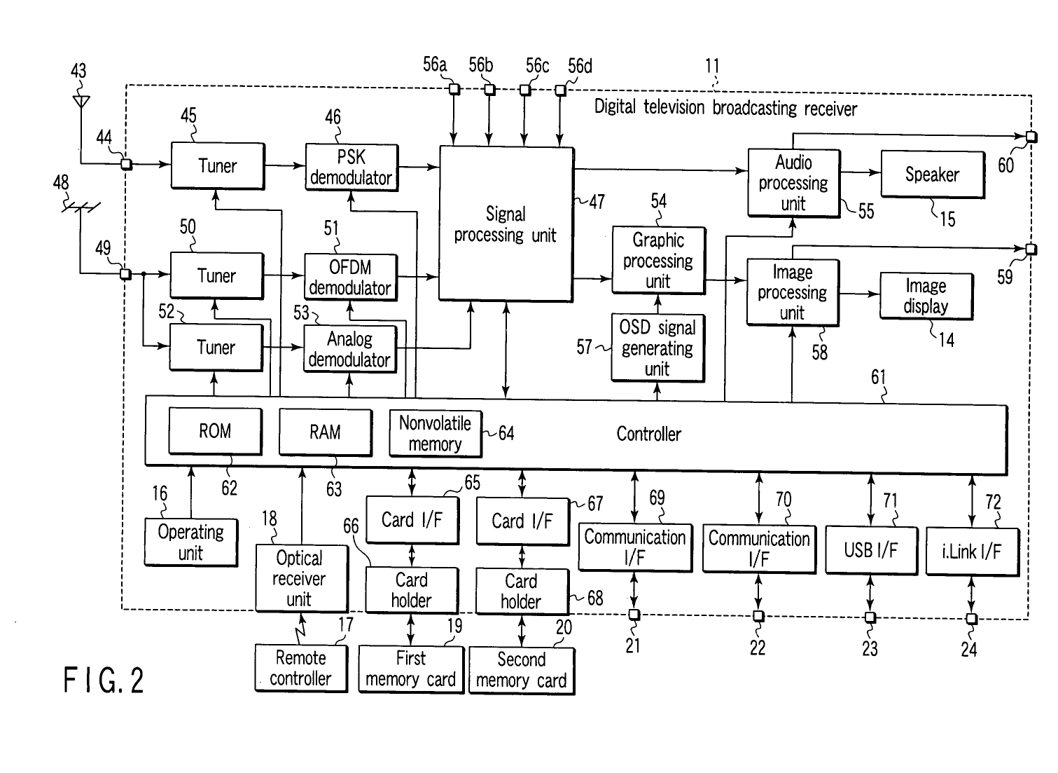

FIG. 2 shows a main signal processing system of the digital television broadcasting receiving apparatus 11. A satellite digital television broadcasting signal received by a BS/CS digital broadcasting receiving antenna 43 is supplied to a satellite digital broadcasting tuner 45 via an input terminal 44, which allows a broadcasting signal of the desired channel to be selected.

The broadcasting signal selected by the tuner 45 is supplied to a PSK (Phase Shift Keying) demodulator 46 and demodulated in the digital video signal and the digital sound signal, and then the digital video signal and the digital sound signal are outputted to a signal processing unit 47.

A terrestrial digital television broadcasting signal received by a terrestrial broadcasting receiving antenna 48 is supplied to a terrestrial digital broadcasting tuner 50 through an input terminal 49, which allows the broadcasting signal of the desired channel to be selected.

The broadcasting signal selected by the tuner 50 is supplied to an OFDM (Orthogonal Frequency Division Multiplexing) demodulator 51 and demodulated in the digital video signal and the digital sound signal, and then the digital video signal and the digital sound signal are outputted to the signal processing unit 47.

A terrestrial analog television broadcasting signal received by the terrestrial broadcasting receiving antenna 48 is supplied to a terrestrial digital broadcasting tuner 52 through the input terminal 49, which allows the broadcasting signal of the desired channel to be selected. The broadcasting signal selected by the tuner 52 is supplied to an analog demodulator 53 and demodulated in the analog video signal and the analog sound signal, and then the analog video signal and the analog sound signal are outputted to the signal processing unit 47.

The signal processing unit 47 selectively performs predetermined digital signal processing to the digital video signals and the digital sound signals, which are supplied from the PSK demodulator 46 the OFDM demodulator 51, and the signal processing unit 47 outputs the digital video signals and the digital sound signals to a graphic processing unit 54 and a speech processing unit 55.

Plural input terminals 56a, 56b, 56c, and 56d (four input terminals in FIG. 2) are connected to the signal processing unit 47. The analog video signal and the analog sound signal can be inputted from the outside of the digital television broadcasting receiving apparatus 11 through the input terminals 56a, 56b, 56c, and 56d.

The signal processing unit 47 selectively digitizes the digital video signals and the digital sound signals, which are supplied from the analog demodulator 53 and the input terminals 56a to 56d. The signal processing unit 47 performs predetermined digital signal processing to the digitized video signals and the digitized sound signals, and the signal processing unit 47 outputs the video signals and the sound signals to the graphic processing unit 54 and the speech processing unit 55.

The graphic processing unit 54 has a function of superposing an OSD (On Screen Display) signal to the digital video signal to output the superposed signal. The OSD signal is generated by an OSD signal generating unit 57, and the digital video signal is supplied from the signal processing unit 47. At this point, the graphic processing unit 54 selectively outputs the output video signal of the signal processing unit 47 or the output OSD signal of the OSD signal generating unit 57, and the graphic processing unit 54 can output both the video signal and the OSD signal such that a half of screen is formed by each output.

The digital video signal outputted from the graphic processing unit 54 is supplied to a video processing unit 58. The video processing unit 58 converts the inputted digital video signal into the analog video signal having a format which can be displayed by the video display device 14, and then the video processing unit 58 outputs the analog video signal to the external device through an output terminal 59 while outputting the analog video signal to the video display device 14 to perform the video display.

The speech processing unit 55 converts the inputted digital sound signal into the analog sound signal having a format which can be reproduced by the speaker 15, and then the speech processing unit 55 outputs the analog sound signal to the external device through an output terminal 60 while outputting the analog sound signal to the speaker 15 to perform the video reproduction.

In the digital television broadcasting receiving apparatus 11, a control unit 61 entirely controls all the actions including the above receiving actions. CPU (Central Processing Unit) and the like are incorporated in the control unit 61. The control unit 61 controls each unit by receiving operation information from the operation unit 16 or by receiving the operation information transmitted from the remote controller 17 through the light-reception unit 18 such that operation contents are reflected.

In this case, the control unit 61 mainly utilizes ROM (Read Only Memory) 62 in which a control program executed by CPU is stored, RAM (Random Access Memory) 63 which provides a working space for the execution of the control program, and a non-volatile memory 64 in which various kinds of setting information and control information are stored.

The control unit 61 is connected to a card holder 66 through a card I/F (interface) 65. The first memory card 19 can be attached to the card holder 66, which allows the control unit 61 to make the information transmission with the first memory card 19 attached to the card holder 66 through the card I/F 65.

The control unit 61 is connected to a card holder 68 through a card I/F 67. The second memory card 20 can be attached to the card holder 68, which allows the control unit 61 to make the information transmission with the second memory card 20 attached to the card holder 68 through the card I/F 67.

The control unit 61 is connected to the first LAN terminal 21 through a communication I/F 69, which allows the control unit 61 to make the information transmission with the LAN-compatible HDD 25 connected to the first LAN terminal 21 through the communication I/F 69. In this case, the control unit 61 has a DHCP (Dynamic Host Configuration Protocol) server function, and the control unit 61 performs the control by assigning an IP (Internet Protocol) address to the LAN-compatible HDD 25 connected to the first LAN terminal 21.

The control unit 61 is connected to the second LAN terminal 22 through a communication I/F 70, which allows the control unit 61 to make the information transmission with the devices connected to the second LAN terminal 22 through the communication I/F 70.

The control unit 61 is connected to the USB terminal 23 through a USB I/F 71, which allows the control unit 61 to make the information transmission with the devices (see FIG. 1) connected to the USB terminal 23 through the USB I/F 71.

The control unit 61 is connected to the i.Link terminal 24 through an i.Link I/F 72, which allows the control unit 61 to make the information transmission with the devices (see FIG. 1) connected to the i.Link terminal 24 through the i.Link I/F 72.

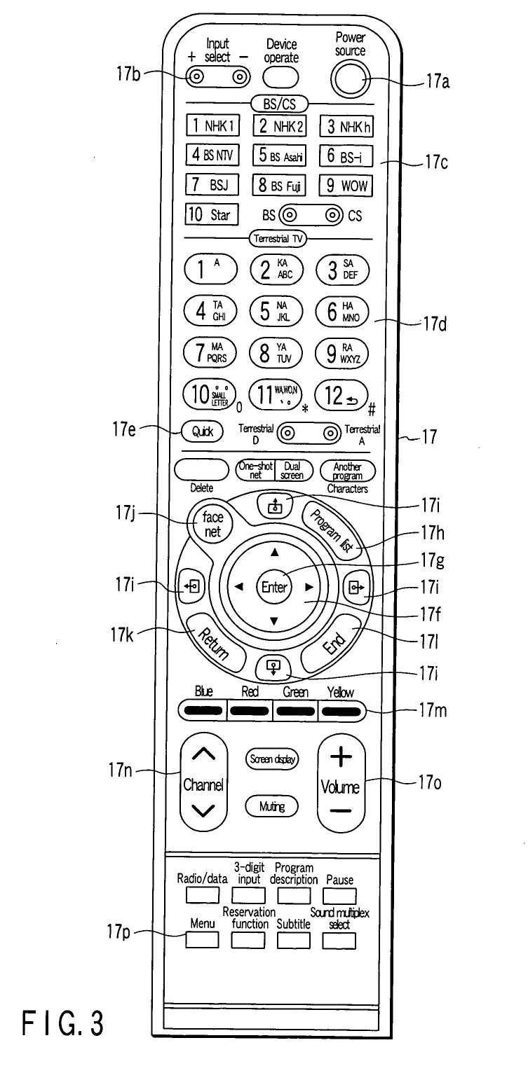

FIG. 3 shows an external appearance of the remote controller 17. A power key 17a, an input switch key 17b, a satellite digital broadcasting channel direct selection key 17c, a terrestrial broadcasting channel direct selection key 17d, a quick key 17e, a cursor key 17f, a determination key 17g, a program listing key 17h, a page switch key 17i, a face net (navigation) key 17j, a return key 17k, an end key 171, blue, red, green, and yellow color keys 17m, channel up and down key 17n, a volume control key 17o, and a menu key 17p are mainly provided in the remote controller 17.

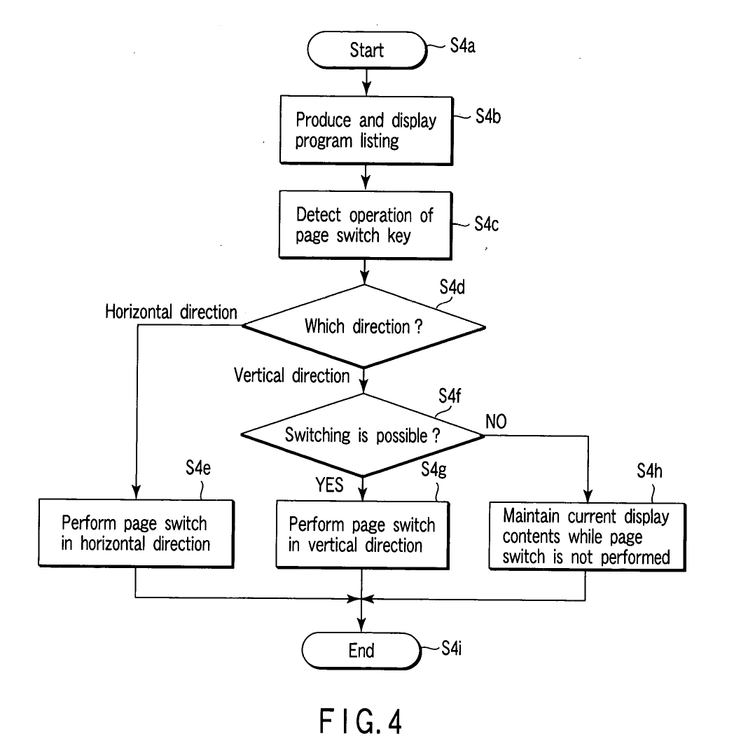

FIG. 4 shows a flowchart for explaining an action in which the digital television broadcasting receiving apparatus 11 performs display switching of the electronic program listings. The action is started (Step S4a) such that the user operates the program listing key 17h of the remote controller 17.

Then, in Step S4b, the control unit 61 produces the electronic program listing based on the EPG information obtained through the broadcasting signal or the network, and the control unit 61 displays a part of the electronic program listing on the video display device 14. The part of the electronic program listing displayed on the video display device 14 is determined based on the latest conditions such as the channel and date and time displayed in the last time.

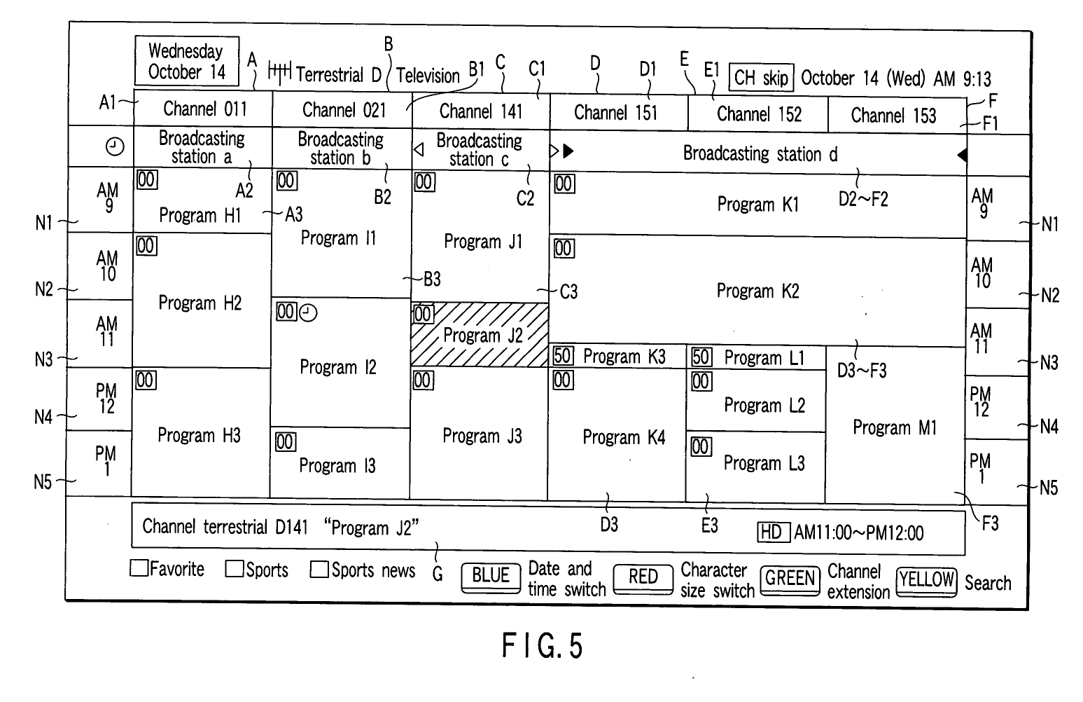

FIG. 5 shows an example of the electronic program listing displayed by the video display device 14. In the electronic program listing of FIG. 5, the programs are displayed such that six broadcasting stations (channels) are arranged in a horizontal direction and five-hour time frames are arranged in a vertical direction.

That is, the electronic program listing has display columns A to F corresponding to the six broadcasting stations (channels), and each of the display columns A to F is formed by channel number display areas A1 to F1, broadcasting station name display areas A2 to F2, and program display areas A3 to F3.

For example, as shown in the display columns D to F, in the case where the same broadcasting station has the plural channel numbers (three channel numbers in FIG. 5), the three broadcasting station name display areas D2 to F2 are used as one common broadcasting station name display area.

In a time slot when the same broadcasting station broadcasts the same program in the plural channel numbers (three channel numbers in FIG. 5), i.e. when one event is shared, the three program display areas D3 to F3 are used as one common program display area.

In the electronic program listing of FIG. 5, a selected program display area G is provided in a lower portion of the six display columns A to F. The program display area G indicates a channel number, a title, and a broadcast time of the program selected by the cursor key 17f of the remote controller 17. In this case, the display area of the selected program “J2” is displayed with a color different from the display areas of other programs in the display columns A to F. However, in FIG. 5, the display area of the selected program “J2” is displayed by hatch lines.

Five time areas N1 to N5 are provided in the electronic program listing of FIG. 5. Each of the time areas N1 to N5 vertically indicates the time frame of each one hour. In FIG. 5, since the current time is 9:13 a.m., the time areas N1 to N5 display the state corresponding to a period of time from 9 a.m. to 1 p.m. When the current time is 10 a.m., the time areas N1 to N5 are changed so as to correspond to the period of time from 10 a.m. to 2 p.m.

In the electronic program listing, the area which is located in the vertical direction and in the horizontal direction of the area currently displayed on the screen is selectively displayed by operating the cursor key 17f or the page switch key 17i in the remote controller 17.

That is, the cursor key 17f of the remote controller 17 has the four operation areas corresponding to the vertical direction and the horizontal direction in order to select a predetermined items from the plural items displayed on the screen.

The electronic program listing, which exists in the direction corresponding to the operation area, is sequentially scrolled and displayed by selectively operating any one of four operation areas of the cursor key 17f.

The page switch key 17i in the remote controller 17 is formed by four kinds of keys which are arranged at positions corresponding to the four operation areas of the cursor key 17f. That is, the page switch key 17i has the four keys corresponding to the vertical direction and the horizontal direction.

When any one of the four keys of the page switch key 17i is selectively operated, the page switch of the electronic program listing currently displayed on the screen can be performed at a dash to the electronic program listing, which exists in the direction corresponding to the operated page switch key 17i and continuously follows the electronic program listing currently displayed on the screen.

The case in which the page switch key 17i is operated will be described below. In the case where a part of the electronic program listing is displayed on the screen in Step S4b, when the control unit 61 detects the operation of the page switch key 17i of the remote controller 17 in Step S4c, the control unit 61 determines in which direction the page switch key 17i is operated.

When the control unit 61 determines that the page switch key 17i is operated in the horizontal direction, the control unit 61 performs the page switch in order to display a portion in the horizontal direction continuously following the electronic program listing currently displayed on the screen, and the control unit 61 ends the process (Step S4i).

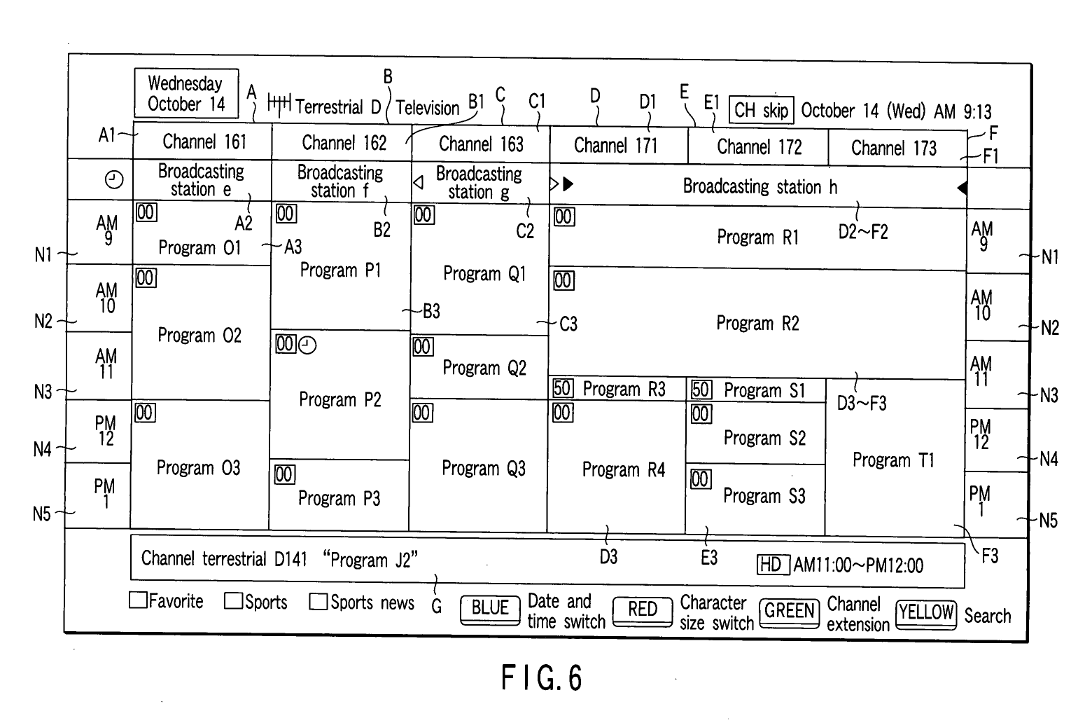

FIG. 6 shows the display screen after the page switch is performed by operating the page switch key 17i rightward in the display state of the electronic program listing shown in FIG. 5. That is, while the time areas N1 to N5 continue to correspond to the period of time 9 a.m. to 1 p.m., the channel number display areas A1 to F1, the broadcasting station name display areas A2 to F2, and the program display areas A3 to F3 are switched to a portion which continuously follows the right side of the electronic program listing shown in FIG. 5.

In Step S4d, when the control unit 61 determines that the page switch key 17i is operated in the vertical direction, the control unit 61 determines whether the page switch can vertically be performed or not in Step S4f.

When the control unit 61 determines that the page switch can horizontally be performed (YES in Step S4f), the control unit 61 performs the page switch in order to display a portion in the vertical direction continuously following the electronic program listing currently displayed on the screen in Step S4g, and the control unit 61 ends the process (Step S4i).

When the control unit 61 determines that the page switch cannot horizontally be performed (NO in Step S4f), the control unit 61 does not perform the page switch in the vertical direction in Step S4h, and the control unit 61 maintains the current display state of the electronic program listing to end the process (Step S4i).

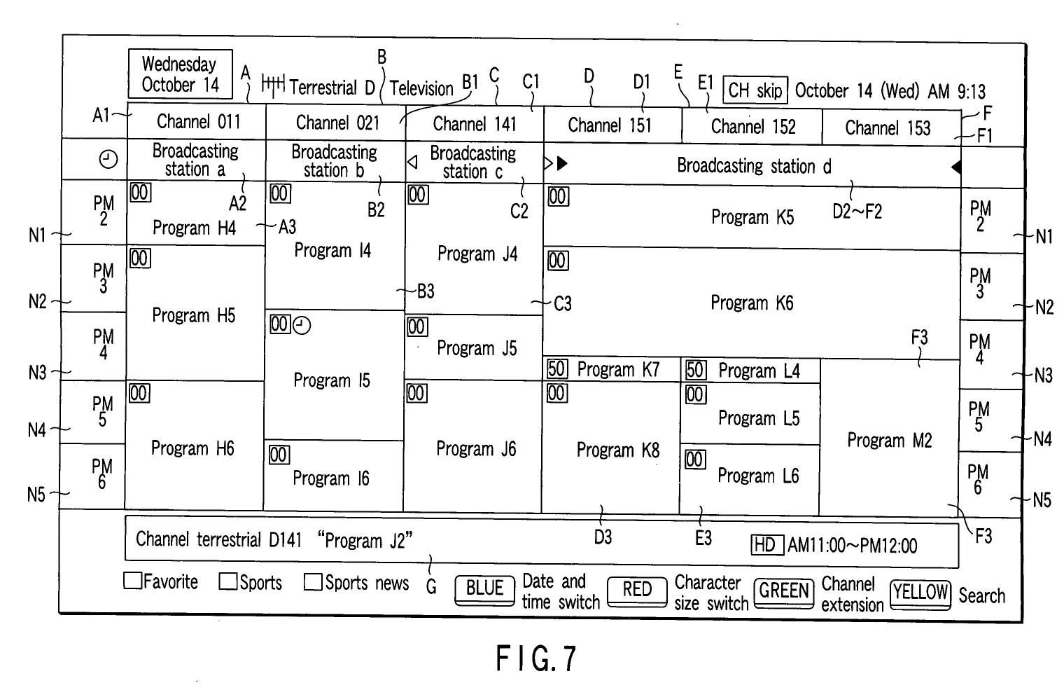

FIG. 7 shows the display screen after the page switch is performed by operating the page switch key 17i downward in the display state of the electronic program listing shown in FIG. 5. That is, while the channel number display areas A1 to F1 and the broadcasting station name display areas A2 to F2 continue to correspond to the period of time 9 a.m. to 1 p.m., the time areas N1 to N5 and the program display areas A3 to F3 are switched to a portion which continuously follows the lower side of the electronic program listing shown in FIG. 5.

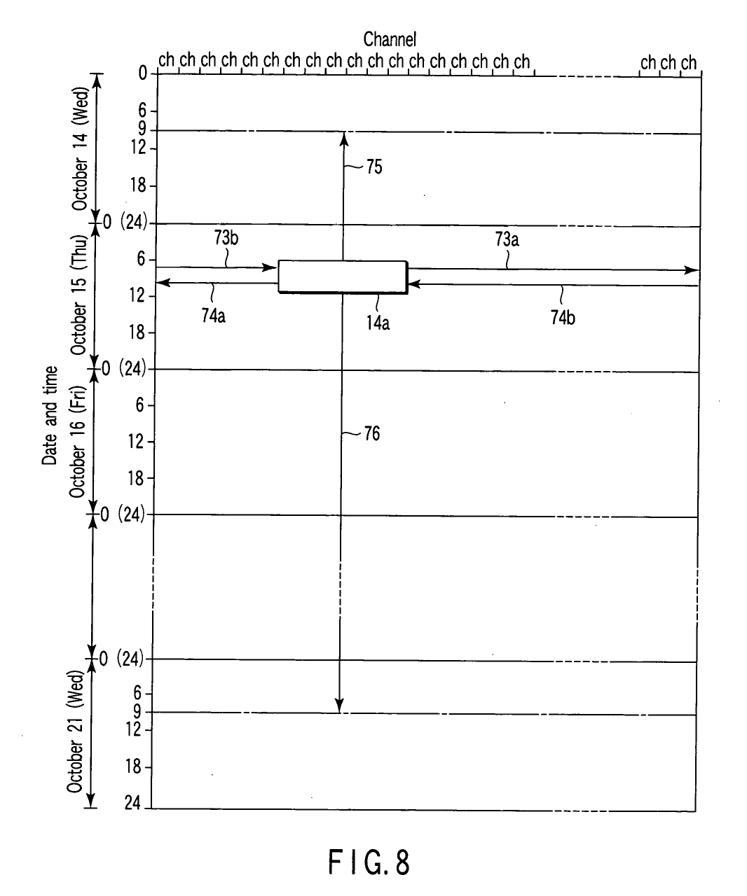

FIG. 8 schematically shows the display switch of the electronic program listings produced from the EPG information to the screen of the video display device 14. In the electronic program listing shown in FIG. 8, a channel axis is provided in the horizontal direction, and a date and time axis is provided in the vertical direction. All the channels which can be received are arranged in the channel axis, and the date and the time are arranged in the date and time axis.

Generally the EPG information is transmitted such that the electronic program listing of about one week can be produced for each of the broadcasted channels. Therefore, when the current data is October 14 (Weds), the dates and the times to October 21 (Thurs) which is one week ahead from October 14 (Weds) are sequentially arranged.

An area 14a of six channels by five hours in the electronic program listing is displayed on the screen of the video display device 14. When the page switch key 17i of the remote controller 17 is operated, the area 14a is moved to a position adjacent to the previous display positioning the direction corresponding to the operated page switch key 17i.

For example, as shown by an arrow 73a in FIG. 8, when the rightward operation of the page switch key 17i is performed each time, the area 14a is sequentially moved rightward on the electronic program listing, and the area 14a reaches the right end portion of the electronic program listing.

When the rightward operation of the page switch key 17i is further performed, the area 14a emerges in the left end portion in the same period of time of the electronic program listing. Then, as shown by an arrow 73b in FIG. 8, cyclic display switch is performed such that the area 14a is sequentially moved rightward on the electronic program listing when the rightward operation of the page switch key 17i is performed each time.

As shown by an arrow 74a in FIG. 8, when the leftward operation of the page switch key 17i is performed each time, the area 14a is sequentially moved leftward on the electronic program listing, and the area 14a reaches the left end portion of the electronic program listing.

When the leftward operation of the page switch key 17i is further performed, the area 14a emerges in the left right portion in the same period of time of the electronic program listing. Then, as shown by an arrow 74b in FIG. 8, the cyclic display switch is performed such that the area 14a is sequentially moved leftward on the electronic program listing when the leftward operation of the page switch key 17i is performed each time.

Thus, when the page switch key 17i is operated in the horizontal direction in Step S4e of FIG. 4, the action of the cyclic display change of the electronic program listing is performed.

When the upward operation of the page switch key 17i is performed each time, as shown by an arrow 75 in FIG. 8, the area 14a is sequentially moved upward on the electronic program listing to perform the display switch.

In this case, in the period of time which has already passed, i.e., in the period of time before 9 a.m. on October 14 (Weds) in FIG. 8, even if the upward operation of the page switch key 17i is performed, the control is performed such that the area 14a is not moved. That is, the control is performed such that the past electronic program listing is not displayed.

When the downward operation of the page switch key 17i is performed each time, as shown by an arrow 76 in FIG. 8, the area 14a is sequentially moved downward on the electronic program listing to perform the display switch.

In this case, in the period of time in which the electronic program listing is not produced because the EPG information is not obtained yet, i.e., in the period of time after 9 a.m. on October 21 (Weds) in FIG. 8, even if the downward operation of the page switch key 17i is performed, the control is performed such that the area 14a is not moved. That is, the display switch can be performed only for the produced electronic program listings.

Thus, in the Step S4f of FIG. 4, when the page switch key 17i is operated in the vertical direction, the control unit 61 determines whether the destination of the area 14a is the period of time which has passed or not, and the control unit 61 determines whether the destination of the area 14a is the period of time in which the electronic program listing is not produced because the EPG information is not obtained yet or not.

According to the embodiment, the page switch of the electronic program listing currently displayed on the screen can be performed at a dash to the portion, which exists in the direction corresponding to the operated page switch key 17i and continuously follows the electronic program listing currently displayed on the screen, by selectively operating any one of the four keys in the page switch key 17i. Therefore, the display area of the electronic program listing can efficiently be switched by the simple operation, and the user operability can be improved.

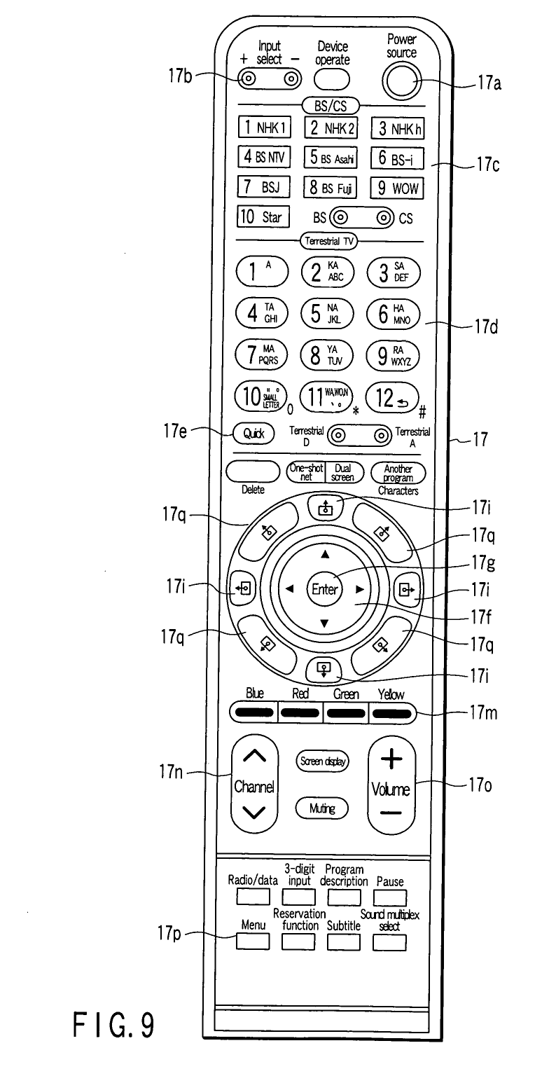

FIG. 9 shows a modification of the above embodiment. A page switch key 17q having four keys corresponding to obliquely upper and lower right directions and obliquely upper and lower left directions is provided in addition to the page switch key 17i having the four keys corresponding to the vertical direction and the horizontal direction.

The provision of the page switch keys 17i and 17q enables the page switch in which the area 14a is moved in eight directions of the four vertical and horizontal directions and the four oblique directions on the electronic program listing. Therefore, the display area of the electronic program listing can efficiently be switched by simpler operation.

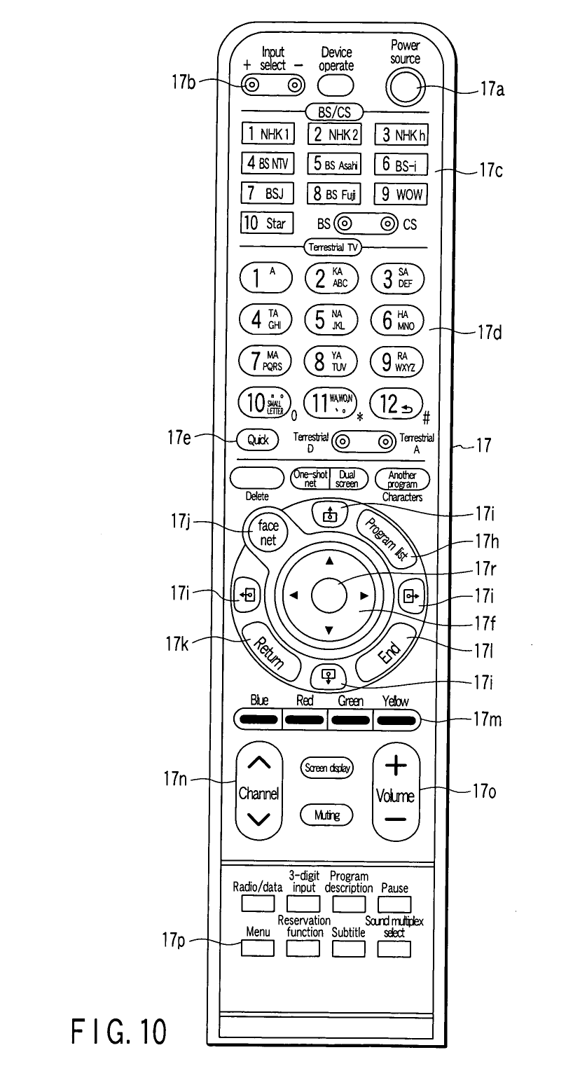

As shown in FIG. 10, when a page switch key 17r having a joystick structure is placed in the remote controller 17, the page switch can be performed toward an arbitrary direction.

The page switch is not limited to the mode in which the display contents are switched at a dash. For example, it is possible to show a sequentially switching procedure from the current display content to the display content of the target position corresponding to the operation of the page switch key 17i.

The invention is not limited to the above embodiment, but the invention can be embodied in the realizing stage by modifying the constituents in various ways without departing from the spirit and scope of the invention. Various inventions can be made by appropriately combining the plural constituents disclosed in the embodiment. For example, it is possible that some components are removed from all the components shown in the embodiments. Further, it is possible that the components in the different embodiments are appropriately combined.

What is claimed is:

1. A program listing displaying apparatus comprising:
an obtaining unit configured to obtain program information;
a producing unit configured to produce an electronic program listing based on the program information obtained by the obtaining unit;
a display unit configured to display a part of area of the electronic program listing produced by the producing unit; and
a switching unit configured to perform page switch of the area of the electronic program listing displayed by the display unit to the area which exists in a specified direction, the area continuously following the area displayed by the display unit.

2. A program listing displaying apparatus according to claim 1, wherein the switching unit is configured to control the page switch such that the page switch to a period of time which has passed becomes impossible.

3. A program listing displaying apparatus according to claim 1, wherein the switching unit is configured to control the page switch such that the page switch to a period of time when the program information is not obtained becomes impossible.

4. A program listing displaying apparatus according to claim 1, wherein the switching unit comprises an operator configured to selectively specify a direction in which the page switch is performed toward a vertical direction and a horizontal direction on a screen.

5. A program listing displaying apparatus according to claim 1, wherein the switching unit comprises an operator configured to selectively specify the direction in which the page switch is performed toward the vertical direction, the horizontal direction, and an oblique direction on the screen.

6. A program listing displaying apparatus according to claim 1, wherein the switching unit comprises an operator having a joystick structure configured to arbitrarily specify the direction in which the page switch is performed.

7. A program listing displaying apparatus according to claim 4, 5 or 6, wherein the operator is placed in a remote controller.

8. A program listing displaying apparatus according to claim 1, wherein the switching unit is configured to perform the page switch in a mode in which display contents are switched at a dash when the direction is specified.

9. A program listing displaying apparatus according to claim 1, wherein the switching unit is configured to perform the page switch in a mode which shows a sequentially switching procedure from the current display contents to the display contents of a target position when the direction is specified.

10. A program listing displaying apparatus according to claim 1, wherein the electronic program listing includes a channel axis and a date and time axis, a plurality of channels being arranged in the channel axis, a date and a time being arranged in the date and time axis, and the switching unit is configured to perform the cyclic page switch with respect to the direction of the channel axis.

11. A program listing displaying method comprising:
a step of obtaining program information;
a step of producing an electronic program listing based on the obtained program information;
a step of displaying a part of area of the produced electronic program listing; and
a step of performing page switch of the area of the displayed electronic program listing to the area, which exists in a specified direction and continuously follows the displayed area.
